(19) United States
(12) Patent Application Publication
(10) Pub. No.: US 2016/0334253 A1
(43) Pub. Date: Nov. 17, 2016

(54) DEVICE FOR MEASURING THE TRAVELLING SPEED OF A FLUID IN RELATION TO AN OBJECT

(71) Applicant: POLYVIONICS, Paris (FR)

(72) Inventor: Stephane Luc Sebastien QUERRY, Paris (FR)

(21) Appl. No.: 15/114,761

(22) PCT Filed: Jan. 28, 2015
(86) PCT No.: PCT/FR2015/050194

§ 371 Date: Jul. 27, 2016

(30) Foreign Application Priority Data
Jan. 28, 2014 (FR) 1450676

(51) Int. Cl. G01F 1/66

(52) U.S. Cl. CPC G01F 1/662

(57) ABSTRACT

Device for measuring the relative speed of movement of a fluid in relation to an object, characterised in that said device comprises at least one sensor 2 positioned in a suitable area of the object, wherein said at least one sensor 2 is capable of identifying and utilising, in conjunction with at least one computer 3, local aerodynamic or hydrodynamic instability, originating from the relative movement of said fluid in relation to an element 1 of said object, depending on the speed of movement of the fluid. The device is characterised in that said element 1 is an obstacle or a hollow cavity with a single opening contained in a body 40 and open towards the outside of said body, wherein said body is positioned on the object, the relative velocity of the fluid of which one wishes to ascertain, such that said cavity 1 is skimmed by the fluid and in that said at least one aerodynamic/hydrodynamic instability sensor 2 utilises the process of self-oscillation of the fluid inside the cavity 1 in order to determine the fluid's relative speed of movement.

### TECHNICAL FIELD OF THE INVENTION

The invention relates to a system capable of measuring the speed of movement of a fluid in relation to an object. Said object may for example be an aerial, terrestrial, marine or space mobile, etc., a wind tunnel, a turbine engine, a duct or a weather station.

### PRIOR STATE OF THE ART

In aeronautics and likewise in other technical fields, the velocity of a fluid in relative flow (airspeed of an aircraft for example) is commonly measured using a Pitot tube. This tube measures the static or ambient pressure in addition to the total pressure, created by the impact of the fluid on a capsule and subsequently calculates the aircraft's airspeed based on an algorithm.

In a number of cases however, the Pitot tube may be subject to blockage, icing for instance in the case of an aircraft owing to its flight altitude, to atmospheric pressure, to environmental temperature and humidity, to the crystals contained in clouds and to the air stagnation points at certain positions in the probe. These elements render this sensor, the Pitot tube, inoperative. By way of an illustration, the Airbus company acknowledged no fewer than 36 incidents involving possible Pitot probe blockage due to ice on A330/A340 aircraft between 12th Nov. 2003 and 7th Aug. 2009.

Under these circumstances, the aircraft may complete its flight under good conditions (whereby the pilots apply specific instructions while flying manually), but this dysfunction may also cause control abnormalities capable of leading to a crash, as reflected by a number of accidents, such as that of Birgenair flight 301 or the recent accident of the Paris-Rio (Air France) flight among others.

### DISCLOSURE OF THE INVENTION

The invention aims to overcome the disadvantages of the state of the art and in particular, propose a device for measuring the relative speed of movement of a fluid in relation to an object. The device comprises at least one sensor positioned in a suitable area of the object, wherein said at least one sensor is capable of identifying and utilising, in conjunction with at least one computer, local aerodynamic or hydrodynamic instability, originating from the relative movement of said fluid in relation to an element of said object, depending on the speed of movement of the fluid, wherein the device is characterised in that said element is an obstacle or a hollow cavity with a single opening contained in a body and open towards the outside of said body, wherein said body is positioned on the object, the relative velocity of the fluid of which one wishes to ascertain, such that said cavity is skimmed by the fluid and in that said at least one aerodynamic/hydrodynamic instability sensor utilises the process of self-oscillation of the fluid inside the cavity in order to determine the fluid's relative speed of movement.

Generally, the object in relation to which the speed of movement of the fluid is measured may be an aerial, terrestrial, marine/river or space mobile, a wind tunnel or a weather station.

In particular, the element generating local aerodynamic or hydrodynamic instability is attached to the object.

According to the different embodiments of the invention, said element is of some kind of three-dimensional shape, convex and/or concave, or a basic geometrical shape, or profiled or not.

According to a specific embodiment of the invention, the obstacle is either a step or a ramp, or a sloping flat surface of the pseudo-ramp type.

Furthermore, the front of said obstacle forms an angle θ of between 0 and 180 degrees with its installation surface.

In addition, another three-dimensional surface may be located downstream from the flow in relation to the obstacle at a distance h from said obstacle, along a Y axis orthogonal to the X axis, wherein said other surface is intended to contain said at least one sensor.

Additionally, said other surface is flat and/or convex and/or concave and forms an angle θ′ of between 0 and 90 degrees with the normal of its installation surface.

In particular, the body in which the cavity is placed is of conical aerodynamic shape, wherein said body may also adopt an airfoil shape or a pseudo-triangular shape of the ramp type according to a cut plane XY.

Additionally, the front of said body forms an angle θ of between 0 and 180 degrees with its installation surface.

According to this embodiment, the cavity comprises a sloping downstream wall, so as to form an angle θ″ larger than 0° with the normal of its installation surface.

According to an embodiment of the invention, the trailing edge or the downstream wall of the cavity forms an angle with the relative flow of the fluid smaller than 90 degrees.

Furthermore, the normal of the opening of the cavity forms an angle between 0 and 90 degrees with the normal of its installation surface.

In addition, the cavity is such that the mean width of its upstream wall, along a Z axis perpendicular to the XY plane, is less than the mean width of its downstream wall, along said Z axis. Also, at least a portion of the walls of said cavity may be flexible.

According to another embodiment of the invention, the element generating local aerodynamic or hydrodynamic instability forms part of the object.

Advantageously, said at least one sensor used to measure aerodynamic or hydrodynamic instability may be selected from among: an inertial sensor, a pressure sensor, a microphone or hydrophone sensor, a vibrating wire sensor, a strain sensor, a force sensor, a displacement sensor, a hot wire sensor, along n axes where (n>=1).

Preferably, said at least one sensor is positioned in a suitable area of the aerodynamic or hydrodynamic instability of the element, in contact or not with said element, inside or outside said element, upstream or downstream from the relative flow of the fluid, on the leading or trailing edge of the element, in direct contact or not with fluid. Advantageously, instability sensors, owing to their ability to measure instabilities, are installed inside the body in walls of the cavity, or against said walls, either inside or outside, by means of a retention system. Furthermore, the element generating local aerodynamic or hydrodynamic instability may comprise at least one temperature sensor, capable of measuring its own temperature and/or at least one pilotable heating resistor in order to regulate the temperature of said device.

Furthermore, the element generating local aerodynamic or hydrodynamic instability comprises at least one sensor for measuring the temperature of the fluid and at least one sensor for measuring static pressure of the fluid (if the latter is compressible).

In particular, the computer housing the storage memory is designed to perform processing operations required to assess the flow velocity of the fluid in relation to said element, wherein said computer is connected to said at least one sensor via communication ports integrated in said computer or via an independent card connected to the computer.

In particular, the computer is capable of performing the following tasks: interfacing with the at least one sensor for importing the latter's measurements; preliminary processing of the data by means of Kalman filtration, a low-pass filter, a sliding polynomial linear regressor; determination of the Fourier transform and the spectral densities of the induced instabilities.

Moreover, said processing operations comprise: determination of the response frequencies in instability, by identification of at least one power peak; estimation of the speed of movement of the fluid in relation to the element and conducting monitoring of the system. In cases in which the element generating instability is an obstacle, processing involves determining one power peak whereas in cases in which said element is a cavity, several power peaks are determined.

Advantageously, the computer is furthermore designed to perform processing operations for adjusting the temperature of the element to a predetermined temperature via interfacing, through use of at least one temperature sensor and subsequently by calculating the command to be sent to at least one heating resistor via interfacing with said at least one heating resistor.

Advantageously, the element comprises vibration sensors, so as to obtain a reference of disturbing vibrations not induced by the fluid, such that the difference between the spectral density of the vibrations induced by the flow of the fluid and the spectral density of the disturbing vibrations allows isolation of the vibrations induced.

Additionally, the computer is capable of comparing the speed calculations derived from the different types of sensor in order to determine whether the sensor(s) is/are operational.

Furthermore, the computer is capable of measuring the intensity of the current passing through each heating resistor, via modules or communication ports designated for this purpose in order to detect a faulty resistor.

According to an embodiment of the invention, the device additionally comprises a power supply system designed to supply voltage and current to the computer and/or the sensors and/or the heating resistor(s) and/or the computer communication port card and a wireless communication system.

Preferably, the element comprises all or part of the modules required for its operation.

Furthermore, the device comprises several computers, several power supply systems and several communication port cards, wherein each element is provided redundantly, so that an element fulfils its function if a similar, redundant element is faulty.

### BRIEF DESCRIPTION OF THE FIGURES

Other characteristics, details and advantages of the invention will become apparent on reading the description below with reference to the appended figures, which will illustrate:

FIG. 1 shows an embodiment of the invention in cases in which the element generating instability is a rod of triangular section, comprising instability (vibration) sensors positioned in the flow of a fluid;

FIG. 2 shows an embodiment of the invention, in cases in which the element generating instability is a sloping three-dimensional surface (“ramp” type), placed alongside another surface intended to contain the instability sensors (pressure and/or microphone sensor);

FIG. 2A shows an embodiment of the invention in cases in which the element generating instability, the obstacle, is a descending step;

FIG. 3 shows a diagrammatic representation of the behaviour of a flowing fluid running into a cavity;

FIG. 4 shows the spectral density of the speed of movement of a wire/ball system in a wind tunnel, for different blowing speeds;

FIG. 5 shows the spectral density of the vibrations of a wall of the cavity, wherein said vibrations have been induced by the flow of a fluid into said cavity, for three different flow velocities of the fluid;

FIG. 6A shows an embodiment of the invention in the XY plane, in cases in which the element generating instability is a cavity, incorporated in an independent body, FIG. 6B in the XZ plane and FIG. 6C shows the conical body containing the cavity 1;

FIG. 7 shows a functional electronic diagram of the invention.

For greater clarity, identical or similar elements are marked by identical reference signs on all the figures.

### DETAILED DESCRIPTION

The operating principle of the present invention is as follows: any element of an object subject to circulation of a fluid may create local aerodynamic instability of the fluid, the characteristics of which, measurable by means of different pressure, vibration sensors, etc. depend on its flow velocity. Hence, the speed of movement or flow velocity of the fluid in relation to the object can be measured in real time, by analysing the measurements performed.

In cases in which the element generating instability is an obstacle, the instability generated by the latter possesses an excitation frequency fs measurable by a sensor and determined according to the following equation:

$${f}_{s} = \frac{St . U}{D}$$

(where St: Strouhal, U: flow velocity, D: a characteristic dimension).

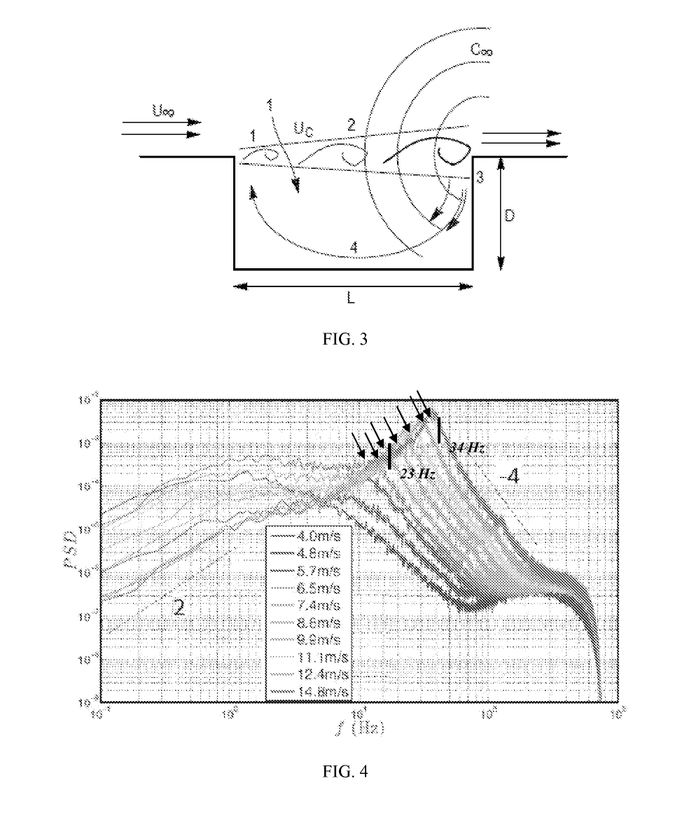

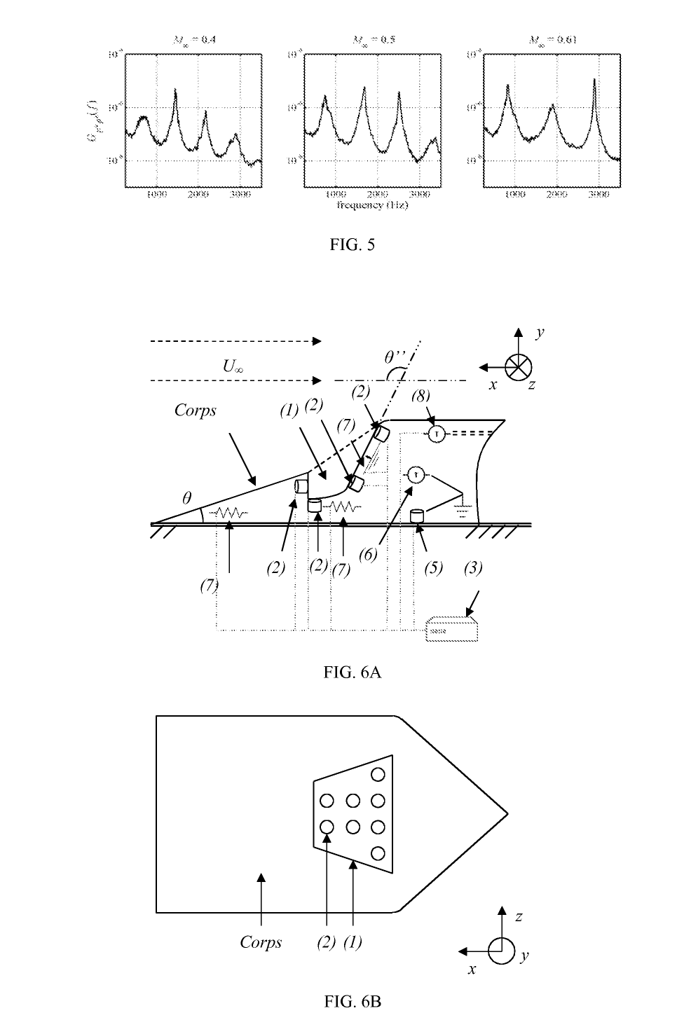

In cases in which the element generating instability is a cavity such as that shown in FIG. 3, the frequencies of this instability fₙ may be determined using Rossiter's formula:

$${f}_{n} = \frac{n - {γ}^{′}}{M + 1 / k} \frac{{U}_{∞}}{L} ,$$

where U_{∞}: flow velocity of the fluid, L: length of the cavity, n: integer representing the mode, k: empirical constant representing the ratio between the propagation speed of the vortices and the unperturbed flow velocity (Rossiter's constant k=0.57), γ′: empirical constant representing the deviation between the impact of the vortex on the edge of the cavity and emission of the acoustic wave (Rossiter's constant γ′=0.25), M: number of mach, equivalent to M=U_{∞}/c, where c, speed of sound in the current environment. It should be noted that the speed of sound (c) may be calculated by the equation: c=\sqrt{γ.Rₛ.T}, where γ: coefficient of compressibility (1.4 for air), Rₛ: specific constant of the gas (287 J·kg⁻¹·K⁻¹ for air) and T: surrounding temperature. When the spectral densities of such vibrations (FIG. 5) are calculated, these frequencies (fₙ) are likewise materialised by density peaks and can thus be readily determined.

This aerodynamic instability is able to create a pressure variation and/or a vibration, of frequency fₛ (in the case of an obstacle) or of frequencies fₙ (in the case of a cavity) and thus be measurable by a pressure sensor, a vibration sensor, a microphone sensor, etc. Hence, by determining the spectral density of the instabilities induced by the flow of the fluid and measured by the sensors and by identifying the frequency fₛ (or the frequencies fₙ) for which the power response is greatest, it is possible to estimate the aerodynamic speed U of the flow of a fluid by knowing the number of Strouhal St of the element.

FIG. 4 shows the spectral density used in order to obtain an initial estimate of the speed of movement or flow velocity of a fluid of a ball blown at different speeds. The spectral density level of the vibrations among specific significant frequencies depends directly on the flow velocity of the fluid. The correlation between the flow velocity and the response frequency

$$\frac{14.8}{9.9} \approx \frac{34}{23} ,$$

in addition to the correlation between the flow velocity and the associated peak power can be clearly seen.

Estimation of the speed is therefore based on a highly important aspect of air-induced vibratory phenomena: vortices in the case of the obstacle and the oscillations sustained formulated by Rossiter in the case of the cavity. It is therefore essential, in order to ensure viability of this method, to clearly define the parameters of the element (in a wind tunnel, or by any other method: calibration, etc.) under all its conditions of use (different directions of the flow (angle of attack), Reynolds conditions, etc.).

### Description According to Particular Embodiments

According to a first embodiment of the invention, the local aerodynamic or hydrodynamic instability may be induced naturally by an element 1, native or intrinsic to the object. For instance, a fuselage, airfoil, tailplane or fin element, etc. in the case of an aerial mobile. When the object is a land vehicle, a bodywork element may act as a generator of the local aerodynamic or hydrodynamic instability. Hence, a hull element, in the case of a marine/river vehicle; an elbow, bend element, etc., for a duct; a pole element for a weather station, may generate local aerodynamic or hydrodynamic instability.

Furthermore, the element 1, generating local aerodynamic or hydrodynamic instability, may be an obstacle or a cavity already present on the object where it performs a specific function; for example, a Pitot tube, and alpha/beta probe, an antenna in the case of an aerial mobile; a rear view mirror, an antenna, . . . for a land vehicle.

The element 1, generating local aerodynamic or hydrodynamic instability, may moreover be a cavity or an obstacle intrinsic to the object. The element 1 may be specifically devoted to this purpose and be installed or attached to any position on the object. For example, fuselage, airfoil, tailplane, fin, etc. in the case of an aerial mobile; bodywork for a land vehicle; hull for a marine/river vehicle; wall for a duct; pole for a weather station.

The element 1 generating local aerodynamic instability may be of some kind of three-dimensional shape, convex and/or concave, a basic geometrical shape, a solid of revolution, a polyhedron, etc., an outside element situated directly in the relative flow of the fluid or an inside element, partially or completely open (cavity) or another element (step, ramp, etc.). The element 1 may or may not be profiled. The presence of sharp edges and sharp angles constitutes an improvement in reducing sensitivity to various parameters: icing (no stagnation point of the fluid), Reynolds number (fixed detachment point(s) of the fluid), etc.

The invention comprises at least one sensor 2, provided redundantly if necessary, capable of measuring aerodynamic instability. This or these sensor(s) may be of different types: inertial type, such as an accelerometer or a gyroscope, pressure sensor type, microphone or hydrophone type (for example: condenser microphone), vibrating wire type sensor, strain sensor (strain gauge, etc.), force sensor, displacement sensor, hot wire sensor, along n axes where (n>=1).

The sensors 2 are positioned in a suitable area of the aerodynamic or hydrodynamic instability of the element 1 in question. They may or may not be in contact with the element 1, inside, outside or on the element 1, upstream or downstream from the relative flow of the fluid, on the leading or trailing edge of the element 1, in direct contact with the fluid or not, through an opening or not, depending on their positions. In cases in which the element 1 is a cavity with a single opening, the aerodynamic/hydrodynamic instability sensor utilises the process of self-oscillation of said fluid within said cavity 1 to determine the fluid's relative speed of movement.

The element 1, generating aerodynamic instability, comprises at least one temperature sensor 6, provided redundantly if necessary, capable of measuring the temperature of said element (which may vary owing to solar radiation, atmospheric temperature, air friction, temperature conduction, . . . ) in order to perform correction of its stiffness coefficient on which its own frequency depends and for its temperature regulation. Said element 1 may also possess at least one heating resistor 7 (provided redundantly if necessary) for its temperature regulation.

The element 1 may furthermore possess at least one sensor for measuring the temperature of the fluid 8 (provided redundantly if necessary). Said sensor 8 may be in contact with the fluid for calculation of the speed of sound in the environment. Likewise, the element 1 may possess at least one sensor for measuring the static pressure of the air 9 (provided redundantly if necessary) for calculation of the density of the air (with knowledge of the fluid temperature).

The device according to the present invention comprises an onboard calculator or computer 3. As illustrated more specifically in FIG. 7, said computer 3, containing the storage memory, is connected to the sensors 2, 6, 8, 9 and to the resistors 7, etc. via communication ports 12, integrated in the computer, or is made available via an independent card. The communication ports 12 may or may not be linked to connectors for any communication with an external system 20. Said external system may comprise a wireless communication card 14, aircraft avionics 15. The aircraft avionics include all the electronic, electrical and IT equipment that assist in piloting the aircraft. The external system 20 may furthermore comprise an airspeed indicator 16. The computer 3 is connected to a power supply system 13. Said power supply system 13 is designed to supply electric current to all the modules (sensors, resistors). The computer 3 is designed to perform the processing operations required to produce the algorithm for estimating the flow velocity of the fluid.

The computer 3 may be entrusted with performing the following tasks: interfacing with the aerodynamic or hydrodynamic instability sensors 2, for importing the latter's measurements; preliminary processing of data (Kalman filtration, low-pass filter, sliding polynomial linear regressor etc.); determination of the Fourier transform and the spectral densities of the induced instabilities (in position, speed or acceleration of the pressures, vibrations or other).

In cases in which the element 1, generating aerodynamic instability, consists of a cavity (FIG. 3), the computer 3 produces the following algorithm:
determination of the response frequencies fₙ in instability (by identification of the power peaks of the different modes) of the spectral density;
estimation of the speed of movement of the fluid in relation to the element 1, by applying the speed calculation equation, as a function of the surrounding speed of sound (c):

$${U}_{∞} = \frac{c . {f}_{n} L}{k ( c ( n - {γ}^{′} ) - {f}_{n} L )} ,$$

where U_{∞}: flow velocity of the fluid,
c: speed of sound in the current environment, fₙ: oscillation frequencies of the cavity, L: length of the cavity, k: empirical constant representing the ratio between the propagation speed of the vortices and the unperturbed flow velocity (Rossiter's constant k=0.57), n: integer representing the mode, γ′: empirical constant representing the deviation between the impact of the vortex on the edge of the cavity and emission of the acoustic wave (Rossiter's constant γ′=0.25).

If the computer 3 knows the temperature of the surrounding fluid, via the temperature sensor 8, or via an external system connected to the computer, it will subsequently be able to calculate the flow velocity of the fluid using the following equation:

$${U}_{∞} = \frac{\sqrt{γ . {R}_{s} . T} {f}_{n} L}{k ( \sqrt{γ . {R}_{s} . T} ( n - {γ}^{′} ) - {f}_{n} L )} ,$$

where γ: coefficient of compressibility (1.4 for air), Rₛ: specific constant of the gas (287 J·kg⁻¹·K⁻¹ for air) and T: surrounding temperature.

In cases in which the element 1, generating aerodynamic instability, is an obstacle, the computer 3 produces the following algorithms:
First algorithm produced by the computer 3:
   determination of the response frequency fₛ in instability (by identification of a power peak) of the spectral density
   estimation of the flow velocity on the system by applying the speed calculation equation:

$$U = \frac{{f}_{s} . D}{St} = \frac{{ω}_{s} . D}{2 π . St} ,$$

where St: Strouhal, U: local flow velocity, D: reference length.
Second algorithm produced by the computer 3:
   determination of the response frequency fₛ in instability (by identification of a power peak) of the spectral density
   acquisition or calculation of the density of the air ρ of the flowing fluid (depending on the air pressure and air temperature) and of the lift coefficient C_{z} of the element 1 causing the instability in addition to the peak power and therefore the coefficient A, finally followed by the speed U (via knowledge of A):

$$A = \frac{0.5 ρ {SU}_{L}^{2} {C}_{z}}{\sqrt{{( {ω}_{0}^{2} - {( 2 π \frac{St . {U}_{L}}{D} )}^{2} )}^{2} + {( 2 m {η ( 2 π \frac{St . {U}_{L}}{D} )}^{2} )}^{2}}}$$

If the element 1 causing the aerodynamic instability is an obstacle, the computer 3, connected to the sensors, can combine both the above equations so as to determine the speed in addition to the Strouhal. In this manner, the computer 3 monitors the system, i.e. checks that the device correctly complies and likewise the computer may detect any variation in Strouhal, due for example to icing, a change in Reynolds, in the direction of flow (or angle of attack), etc.

Indeed, the element 1 causing the aerodynamic instability may experience a change in the Strouhal number and in C_{z}, as a function of the direction α of flow (angle of attack) and the computer 3 may be aware of this angle of attack (α) by means of other sensors or other avionic systems. In this case, the Strouhal numbers and the C_{z}, for each angle of attack (α), will have been determined beforehand in a wind tunnel and the estimation algorithm will use these Strouhal numbers and the C_{z}, as a function of the angle of attack (α) known by the computer, to calculate the airspeed.

A power peak can be identified by different means: calculation and analysis of trend(s), calculation and analysis of drift(s), etc.

The element 1 generating aerodynamic instability may contain several vibration sensors 5 placed at different positions, provided redundantly if necessary, so as to obtain a reference of disturbing vibrations not induced by the fluid. Hence, a difference between the spectral density of the vibrations induced (by the flow of the fluid) and the spectral density of the disturbing vibrations allows isolation of the vibrations induced.

Furthermore, the computer 3 may perform all the processing operations allowing adjustment of the temperature of the element 1 generating aerodynamic instability to a predetermined temperature entered by the user. The processing performed in this case by the computer 3 for regulating the temperature of the element 1 is as follows:
interfacing of the temperature sensor 6 of the element 1 for importing the temperature measurements,
algorithm for regulating the temperature of the device for calculating the command to be sent to a heating resistor 7,
interfacing with the heating resistor(s) 7 for sending the command.

As illustrated in FIG. 7, the sensors and resistors may be connected to a computer 3, to microprocessors and/or microcontrollers containing the storage memory. Communication ports 12 integrated in the computer 3 or made available via an independent card connected to said computer provide the links between the modules (sensors, resistors) and the computer.

The device may furthermore comprise a power supply system 13 (module or electronic supply card for example) contained or not contained in the element 1 causing the aerodynamic instability. The power supply system 13 is designed to supply appropriate electric current to all the modules: the sensors 2, 6, 8 and the heating resistors 7, the card providing the communication ports 12 to the computer 3 and a wireless communication system 14, etc.

Additionally, the computer 3 may be linked to connectors designed to supply electric current to said computer 3, to the sensors, the heating resistors 7, the card providing the communication ports 12 to the computer 3 and the wireless communication system 14, etc. Said connectors are linked to the communication ports 12 of the computer 3 for data exchange with a wireless communication system 14, for which estimation of the flow velocity is intended.

Furthermore, the computer 3 employs communication protocols, via its communication ports 12, in order to receive the data essential to its functioning (configuration, control temperature, etc.), any external data required (ambient air temperature, angle of attack, etc.) and likewise for transmitting important data (estimation of the flow velocity, failure of a sensor, failure of a heating resistor, blockage of a duct, etc.).

On reliability and safety grounds, the device which is the subject of the present invention may include several redundant computers 3, several redundant supply cards 13 and/or several redundant communication port cards, so that a viable element would fulfil its duty if a similar, redundant element were to fail. In addition, the following operations may be carried out:
the computer 3 compares the measurements by the redundant modules (sensors, resistors) or the speed calculations derived from the different types of sensor 2 in order to identify the no longer operational modules;
The computer 3 is capable of measuring the intensity of the current passing through each heating resistor 7 in order to detect a faulty resistor;
The computer 3 can merge the airspeed estimations obtained from the conventional Pitot tube (measurement of the static and total pressures) and the vibration measurements (methods involving analysis of the spectral density) in order to improve the performances of the device in terms of precision and robustness.

In accordance with an embodiment of the invention, the element 1 generating aerodynamic instability may be hollow, in order to contain some or all the elements required for its operation, i.e.: an aerodynamic instability sensor or sensors, the other sensors, a heating resistor or resistors, a data processing computer or computers, a wireless communication card or cards 14, a power supply card or cards 13, a card or cards providing communication ports 12 to the computer and a connector or connectors, etc.

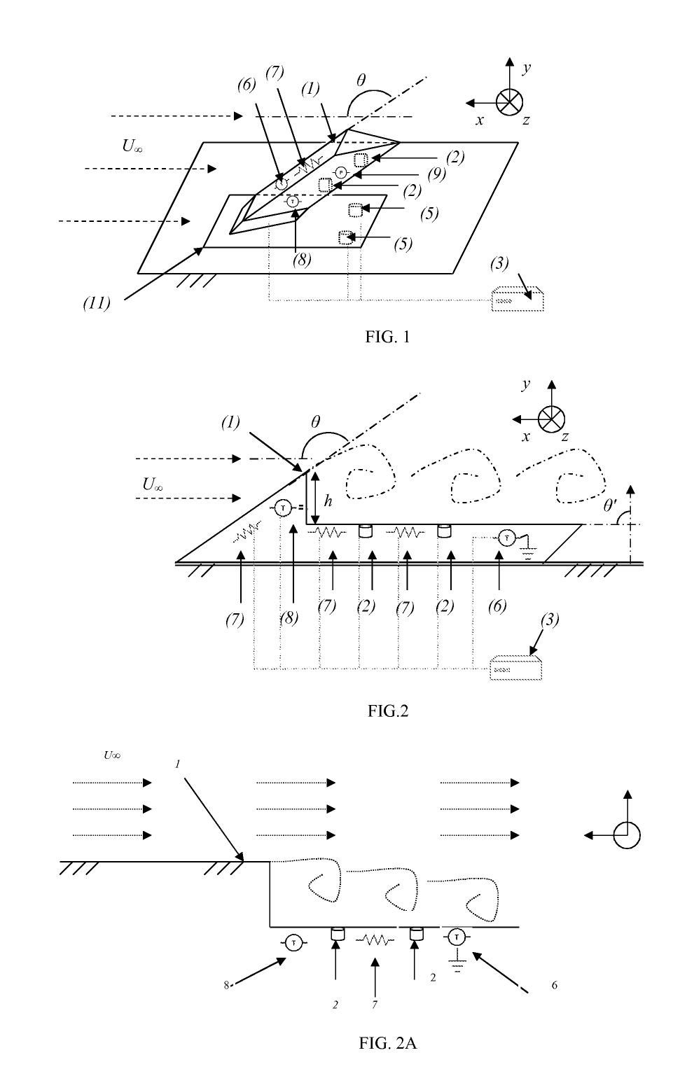

With reference to the drawings, FIG. 1 illustrates an embodiment of the invention and involves an element 1 specifically developed to be located in the fluid flow and generate instabilities which are measured by inertial vibration sensors 2 (accelerometers) and if appropriate, pressure sensors. The aerodynamic shape of the element 1 may or may not be profiled.

In the case of a profiled shape: the wake is only slightly disturbed and hence there are few instabilities to be measured and an undetached flow is present (in normal operation). The option however detects at best instabilities induced by the flow of the fluid so as to reduce the noise/vibration factor and thus obtain an optimum measurement.

In the case of a non-profiled shape: the flow of the fluid induces more instabilities to be measured, with more disturbance of the wake (with vortices). Moreover, the rounded shapes have mobile detachment points (less easy to utilise), whereas the sharp edges of the fixed detachment points are easier to utilise.

The element 1 may also be of a shape for which the Strouhal depends as little as possible on the Reynolds number and on the direction of flow (incidence). The front of the element 1 of the probe forms an angle θ (larger than 90 degrees (obtuse angle)) with its installation surface, so as to:
avoid retaining ice (not having any stagnation points of the fluid)
bounce any crystals crashing into the frontal area of the rod. In this specific case, an element 1 of the “Rod with a triangular cross section” type is selected, as illustrated in FIG. 1, for the following reason:
   the element 1 is situated directly in the fluid flow; the front of said element 1, located upstream from the flow, does not have a stagnation point and consequently said edge does not retain ice. However, the edges of the element 1 allow generation of vortices and therefore the instability, which will be measured to calculate the speed of movement of the fluid in relation to said element 1.

The rigid rod 1, which may be metallic, is machined so as to be hollow, in order to contain all the modules (sensors and resistors) required for its operation. On one of the two triangular faces of this rod 1, a secondary rod 10 is added, which forms the interface between the main triangular rod 1 and the mounting fitting of a probe 11. This secondary rod 10 has two functions: moving the main triangular rod 1 away from the boundary layer and providing a (possibly metallic) material more flexible than the main triangular rod 1 so as to increase the oscillations of said main triangular rod 1 induced by the aerodynamic/hydrodynamic instabilities, thereby allowing their detection.

A temperature sensor 6 of the probe 11 is integrated within the main triangular rod 1, in addition to a heating resistor 7, in order to control the temperature of the probe 11 depending on the user's instructions and correct the estimation of the stiffness coefficient (and therefore the own frequency ω₀) of all the rods as a function of the temperature.

The main triangular rod 1 furthermore comprises sensors measuring the pressure 9 and sensors measuring the temperature of the fluid 8, in order to determine, in the case of a gaseous fluid, the density p of the fluid and the speed of sound in the medium. Said main rod 1 furthermore comprises a sensor or sensors measuring the pressure of the fluid 2 and vibration sensors 2 (one single sensor is visible in FIG. 1) in order to measure the pressure oscillations of the fluid in the instability area and the vibration oscillations of the main rod 1, derived from the instability of the fluid wake. At least one vibration sensor 5 may be installed on the mounting fitting in order to allow a computer 3, responsible for estimating speed, to obtain a reference of the disturbing vibrations originating from the position at which the main triangular rod 1 is installed.

Another embodiment of the invention, illustrated in FIG. 2, involves using a sloping flat surface of the “pseudo-ramp” type as the element 1 generating instability. The angle θ between the front of the obstacle 1 (pseudo-ramp) and its installation surface is larger than 90 degrees (obtuse angle), so as to avoid retaining ice (it does not have any stagnation points of the fluid) and bounce any crystals crashing into the frontal area of the obstacle 1 (pseudo-ramp). Another surface 30 of any shape, which may be hollow, is located downstream from the flow in relation to the element 1. This other surface 30 is intended to contain the instability sensors 2 (pressure sensor(s), microphone sensor, etc.) that are used to determine the speed. This other surface 30 is situated at a distance h from the element generating instability 1, along the Y axis, in order to allow the vortices to have adequate room to develop, whilst being able to measure the latter. This other surface 30 may be flat and/or curved (convex and/or concave) and forms an angle θ′ of between 0 and 90 degrees with the normal of its installation surface.

FIG. 2A illustrates another embodiment of the invention in which the element 1 is a descending step and the instability sensors 2 (pressure sensor(s), microphone sensor, etc.) that are used to determine speed are positioned below the flat surface of the step.

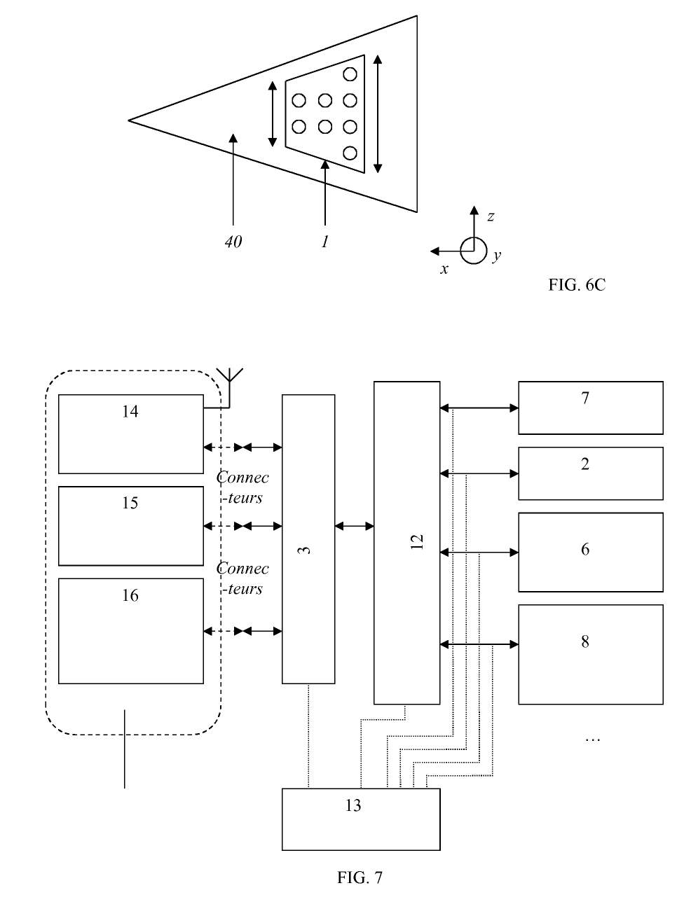

With reference to FIGS. 6A and 6B, a third embodiment of the invention involves a body 40 specifically developed to be situated in the fluid flow and generate instabilities by means of a cavity 1. The instabilities are measured by instability sensors 2 placed inside said cavity 1. The body 40 is positioned in the relative flow of the fluid. Said body 40 is metallic and hollow in order to contain elements specific to the invention. The cavity 1 is open towards the outside (one single opening) of the body 40 and is arranged such that the fluid can enter its inside. The body 40, in addition to the cavity 1, may be executed as a machined block or in several parts. The body 40 adopts a pseudo-triangular shape in the XY plane (“ramp” type), so as not to have any stagnation point, in order not to retain ice. The downstream wall of the cavity 1 has a dimension along the Y axis greater than that of its upstream wall. The downstream wall slopes in relation to the YZ plane in order to allow any crystals contained in the fluid to bounce on this downstream wall and avoid accumulating in the cavity 1. The walls of the cavity 1 are preferentially flexible in order to detect the vibrations induced by the flow of the fluid. Said walls have all the positions for pressure and vibration sensors 2, in addition to condenser microphones, all linked to the computer 3 that calculates the relative speed of movement of the fluid in relation to the cavity 1. FIG. 6C likewise illustrates a conically shaped body 40 in which the cavity 1 is contained in the XY plane. The downstream wall of the cavity 1 has a dimension along the Y axis greater than that of its upstream wall.

The pressure sensors 2 in addition to the condenser microphones are in contact with the fluid, whereas the vibration sensors may be rigidly attached to the walls of the cavity 1, but inside the body. The temperature sensor 6 of the probe and the heating resistors 7, designed to control the temperature of said probe, are likewise installed inside the body. The sensor for measuring the temperature of the fluid 8 is designed to determine the value of the speed of sound in the ambient environment.

The device according to the present invention is applied to estimating the speed of movement of a fluid in relation to an aerial, terrestrial, marine (maritime/river), submarine or spatial/planetary mobile, or within a wind tunnel or a turbine engine. It also allows estimation of a gaseous fluid (wind) moving in a natural medium: weather station, wind power station, etc.

Furthermore, the device according to the present invention is applied to estimating a liquid fluid (water) in motion in a natural medium (stream, creek, river, lake, sea, etc.), or in a man-made medium (piping, pipeline, dam, water purification plant, etc.).

Many combinations may be envisaged without departing from the framework of the invention; the person skilled in the art will select one or the other depending on the economic, ergonomic, dimensional or other constraints to be observed.

1. Device for measuring the relative speed of movement of a fluid in relation to an object, comprising at least one sensor (2) positioned in a suitable area of the object, wherein said at least one sensor (2) is capable of identifying and utilising, in conjunction with at least one computer (3), local aerodynamic or hydrodynamic instability, originating from the relative movement of said fluid in relation to an element (1) of said object, depending on the speed of movement of the fluid, wherein the device is characterised in that said element (1) is an obstacle or a hollow cavity with a single opening contained in a body (40) and open towards the outside of said body, wherein said body (40) is positioned on the object, the relative velocity of the fluid of which one wishes to ascertain, such that said cavity is skimmed by the fluid and in that said at least one aerodynamic/hydrodynamic instability sensor (2) utilises the process of self-oscillation of the fluid inside the cavity (1) in order to determine the fluid's relative speed of movement.

2. Device according to claim 1, wherein the obstacle (1) is either a step or a ramp, or a sloping flat surface of the pseudo-ramp type.

3. Device according to claim 2, wherein the front of said obstacle (1) forms an angle θ of between 0 and 180 degrees with its installation surface.

4. Device according to claim 2, wherein a surface (30) of any three-dimensional shape may be located downstream from the flow in relation to the obstacle (1) at a distance h from said obstacle (1), along a Y axis orthogonal to the X axis, wherein said surface (30) is intended to contain said at least one sensor (2).

5. Device according to claim 4, wherein said surface (30) is flat and/or convex and/or concave and forms an angle θ′ of between 0 and 90 degrees with the normal of its installation surface.

6. Device according to claim 1, characterised in that the body (40) in which the cavity (1) is placed is of conical aerodynamic shape, wherein said body (40) may also adopt an airfoil shape or a pseudo-triangular shape of the ramp type according to a cut plane XY.

7. Device according to claim 6, wherein the front of the body (40) forms an angle θ of between 0 and 90 degrees with its installation surface.

8. Device according to claim 1, wherein the cavity (1) comprises a sloping downstream wall, so as to form an angle θ″ larger than 0° with the normal of its installation surface.

9. Device according to claim 8, characterised in that the trailing edge, the downstream wall of the cavity (1), forms an angle with the relative flow of the fluid smaller than 90 degrees.

10. Device according to claim 7, characterised in that the normal of the opening of the cavity (1) forms an angle between 0 and 90 degrees with the normal of its installation surface.

11. Device according to claim 1, wherein the cavity (1) is such that the mean width of its upstream wall, along a Z axis, is less than the mean width of its downstream wall, along said Z axis.

12. Device according claim 1, wherein said at least one sensor (2) used to measure aerodynamic or hydrodynamic instability may be selected from among: an inertial sensor, a pressure sensor, a microphone or hydrophone sensor, a vibrating wire sensor, a strain sensor, a force sensor, a hot wire sensor or a displacement sensor, along n axes where (n>=1).

13. Device according to claim 12, wherein said at least one sensor (2) is in contact or not with the element (1), inside, outside or on said element (1), upstream or downstream from the relative flow of the fluid, on the leading or trailing edge of the element (1), in direct contact or not with fluid.

14. Device according to claim 13, characterised in that the instability sensors (2), owing to their ability to measure instabilities, are installed in walls of the cavity (1), or against said walls, by means of a retention system.

15. Device according to claim 1, wherein the element (1) (and/or the body (40) if applicable) comprises at least one temperature sensor (6), capable of measuring its own temperature and/or at least one pilotable heating resistor (7) in order to regulate the temperature of said device.

16. Device according to claim 15, wherein the element (1) comprises at least one sensor for measuring the temperature of the fluid (8).

17. Device according to claim 1, wherein the element (1) comprises at least one sensor for measuring the static pressure of the fluid (9).

18. Device according to claim 1, wherein the computer (3) housing the storage memory is designed to perform processing operations required to assess the flow velocity of the fluid in relation to said element (1), wherein said computer (3) is connected to said sensors (2) via communication ports (12) integrated in said computer (3) or via an independent card connected to the computer (3).

19. Device according to claim 18, wherein the computer (3) is capable of performing the following tasks: interfacing with the sensors (2) for importing the latter's measurements; preliminary processing of the data by means of Kalman filtration, a low-pass filter, a sliding polynomial linear regressor; determination of the Fourier transform and the spectral densities of the induced instabilities.

20. Device according to claim 18 in which treatments comprise:
determination of the response frequencies in instability, by identification of at last one power peak,
estimation of the speed of movement of the fluid in relation to the element (1); and
conducting monitoring of the system.

21. Device according to claim 18, characterised in that the element (1) comprises vibration sensors (5), so as to obtain a reference of disturbing vibrations not induced by the fluid, such that the difference between the spectral density of the vibrationsn induced by the flow of the fluid and the spectral density of the disturbing vibrations allows isolation of the vibrations induced.
